(19) United States
(12) Patent Application Publication
(10) Pub. No.: US 2015/0070583 A1
(43) Pub. Date: Mar. 12, 2015

(54) SYNCHRONIZATION OF VIDEO AND REAL-TIME DATA COLLECTION STREAMS

(71) Applicant: TOMORROW OPTIONS-MICROELECTRONICS, S.A., Porto (PT)

(72) Inventors: João Henrique do Cubo Neiva, Porto (PT); Jorge Miguel Almeida Moreira Pinto, Baguim do Monte (PT); Pedro Miguel Magalhães Quelhas, Maia (PT); Piotr Wojewnik, Warszawa (PL)

(21) Appl. No.: 14/351,771

(22) PCT Filed: Sep. 24, 2012
(86) PCT No.: PCT/IB2012/055076

§ 371 Date: Apr. 14, 2014

(30) Foreign Application Priority Data
Sep. 23, 2011 (PT) 105902

(51) Int. Cl. H04N 5/12; G06T 1/00

(52) U.S. Cl. CPC H04N 5/12; G06T 1/0021
USPC 348/500

(57) ABSTRACT

System and method for synchronizing a video stream (C) with a real-time data collection stream (A) of the same and simultaneous physical setting comprising a time- or frame-reference (t) module (1) from the data processor (2) responsible for collecting the data stream (A) from the physical setting, a generator (3) of an encoded video stream (B′), in particular a barcode, a display (4), a camera (5) for collecting the video stream (C) from the physical setting and in the same video stream (C/B′) of said physical setting, a decoder (6) of the visually encoded time- or frame-reference (B′), connected to receive the filmed encoded video stream (C) with encoded image patterns (B′) and obtain the visually encoded time- or frame-reference (t′), and a synchronization module (7) which outputs the synchronized streams (A′+C) of the synchronized video stream (C) and the synchronized real-time data collection stream (A′) of said physical setting.

### TECHNICAL FIELD

The technical field relates to the synchronization of a video stream with real-time data collection stream or streams, by means of an unsynchronized video camera and a displayed synchronized time-encoded video stream.

### SUMMARY

An embodiment describes a method for synchronizing a video stream with a real-time data collection stream of the same and simultaneous physical setting comprising the steps of:
providing a time- or frame-reference (t) by the data processor (2) responsible for collecting the data stream (A) from the physical setting, or by another data processor (8) in temporal synchronization with the data processor (2) responsible for collecting the data stream (A) from the physical setting;
visually encoding (3) said time- or frame-reference (t) into an encoded image pattern and generating an encoded video stream (B′) comprising said encoded image pattern;
displaying (4) said encoded video stream (B′);
filming (5) said displayed encoded video stream (B′) by a camera responsible for collecting the video stream (C) from the physical setting and in the same video stream of said physical setting (C/B′);
decoding (6) said encoded image pattern from the filmed encoded video stream (C/B′) and obtaining the visually encoded time- or frame-reference (t′);
using (7) this time- or frame-reference (t′) to synchronize (A′+C′) the video stream of said physical setting (C) with the real-time data collection stream of said physical setting (A).

In a further embodiment the step of visually encoding (3) time- or frame-reference (t) into an encoded image pattern comprises generating a barcode with a time- or frame-reference (t).

In a further embodiment the step of visually encoding (3) time- or frame-reference (t) into an encoded image pattern comprises generating a linear or 2D barcode with a numerical time-reference (t).

In a further embodiment the step of visually encoding (3) time- or frame-reference (t) into an encoded image pattern comprises generating a black and white barcode with a numerical time-reference (t) in milliseconds.

In a further embodiment the step of visually encoding (3) time- or frame-reference (t) into an encoded image pattern comprises generating a UPC-A barcode with a numerical time-reference (t) in milliseconds.

In a further embodiment the step of visually encoding (3) time- or frame-reference (t) into an encoded image pattern comprises generating a linear or 2D barcode with an alphanumerical time- or frame-reference.

In a further embodiment the 2D barcode is a 2D matrix code, 2D stacked code or a 2D high-density color barcode, or combinations thereof.

In a further embodiment the filming (5) of said displayed encoded video stream (B′) occurs before, or after, or before and after, the simultaneous filming (5) of the video stream (C) and collecting the real-time data (A) from the same physical setting.

In a further embodiment the step of decoding (6) of said encoded image pattern, from the filmed encoded video stream (C/B′), and obtaining the visually encoded time- or frame-reference (t′), comprises calculating the median time- or frame-reference from a plurality of frames from the encoded video stream (C/B′).

An embodiment describes a computer program comprising computer program code means adapted to perform the steps of any of the previous embodiments when said program is run on a processor.

An embodiment describes a computer readable medium comprising the previous computer program.

An embodiment describes a system for synchronizing a video stream with a real-time data collection stream of the same and simultaneous physical setting wherein it is configured to perform the steps of any of the previous method embodiments.

An embodiment describes a system for synchronizing a video stream with a real-time data collection stream of the same and simultaneous physical setting comprising:

a time- or frame-reference module (1) from the data processor (2) responsible for collecting the data stream (A) from the physical setting, or from another data processor (8) in temporal synchronization with the data processor (2) responsible for collecting the data stream (A) from the physical setting;
a generator (3) of an encoded video stream (B′), said generator (3) comprising a visual encoder of encoded image patterns of the time- or frame-reference (t) of the time- or frame-reference module (1);
a display (4) connected to the generator (3) of said encoded video stream (B′) able to display said encoded video stream (B′) for filming by a camera (5) for collecting the video stream (C) from the physical setting, and in the same video stream (C/B′) of said physical setting video stream (C);
a decoder (6) of the visually encoded time- or frame-reference (B′), connected to the output of the camera (5) for filming said encoded video stream (C/B′) with encoded image patterns (B′), for decoding and obtaining the visually encoded time- or frame-reference (t′);
a synchronization module (7) connected to said decoded time- or frame-reference (t′) and to the unsynchronized streams (C/B′), for outputting the synchronized streams of the video stream (C′) and the real-time data collection stream (A′) of said physical setting.

In a further embodiment the visual encoder of said time- or frame-reference of the generator (3) of the encoded video stream (B′), comprises a barcode generator connected to the time- or frame-reference (t) from the time- or frame-reference module (1).

In a further embodiment the visual encoder of said time- or frame-reference of the generator (3) of the encoded video stream (B′), comprises a linear or 2D barcode generator connected to a numerical time reference (t) from the time- or frame-reference module (1).

In a further embodiment the visual encoder of said time- or frame-reference of the generator (3) of the encoded video stream (B′), comprises a black and white barcode generator connected to a numerical time reference (t) in milliseconds from the time- or frame-reference module (1).

In a further embodiment the visual encoder of said time- or frame-reference of the generator (3) of the encoded video stream (B′), comprises a UPC-A barcode generator connected to a numerical time- or frame-reference (t) from the time- or frame-reference module (1).

In a further embodiment the visual encoder of said time- or frame-reference of the generator (3) of the encoded video stream (B′), comprises a linear or 2D barcode generator connected to an alphanumerical time- or frame-reference (t) from the time- or frame-reference module (1).

### BACKGROUND

Many applications require a device which records (both on-line and real-time data), in this case one can consider an example of a device which processes and analyzes foot pressure in real time, herein referred as walkinsense, synchronized with the system time of the computer to which it is assigned. The prior art synchronization process is: the computer sends its current system time to the device, the device accepts it as a beginning time reference (0) and starts measuring time from it, sending an ACK back to the computer. The recordings can be displayed on a computer, but it is very difficult for the user to find data points corresponding to a specific moment observed during the tests.

### DISCLOSURE

Many applications require a device which records (both on-line and real-time data), in this case one can consider an example of a device which processes and analyzes foot pressure in real time, herein referred as walkinsense, synchronized with the system time of the computer to which it is assigned.

To make this connection, it would be beneficial to display a video recording taken during the test and match its video frames to the data, thus allowing the user to easily search for the moment of interest.

From the user's point of view, the way of synchronizing the video with the data should be portable and as simple to use and cheap as possible, preferably making use of devices which are already at the user's disposal, like mobile phones, handheld cameras, computer webcams etc. As it is to be used primarily as a search tool, the absolute accuracy of the synchronization is of secondary importance, but the delay between the video and the data should not normally exceed more than two frames from the video.

For such successful integration with the company's products, the libraries for video playback and synchronization need to be compatible with the walkinsense, an example of a device which records, processes and analyzes on-line and real-time data, Java-based software, which makes Java the programming language of choice and calls for a multi-platform solution—or at least one that would be supported at least on Windows and Macintosh operating systems, both 32- and 64-bit. The skilled person will understand that other platforms, languages can also be used for the software.

As a wide range of devices may have to be supported, there is a very limited possibility of accessing their hardware or drivers, the only exception being web cameras—which, for the sake of simplicity, herein comprises all video recording devices controlled by a machine with an operating system, e.g. Android. One of the possible approaches would be to control the recording process directly and put a time marker in the video file. However, if the camera is mounted on a different device than the computer which provides the time for the walkinsense, as an example of a device which records, processes and analyzes on-line and real-time data, the aforementioned marker would only be useful if the difference between the device's and the computer's time is known.

Since many devices, most notably handheld cameras, store the real date and time in their video files, other approach is to search for meta-data in several most widely used video file formats. As in the previous solution, the time difference has to be accounted for.

The implemented approach is to embed a marker in the actual recording/online capture, i.e. in the video and/or audio streams. Although it is a less user-friendly solution, it eliminates the problem of device-computer time difference elimination, since the source of the marker can be anything—the most promising sources being the computer screen or a custom-built device.

To synchronize with virtually any device, it is not a viable approach to access it directly, i.e. via its hardware/drivers, as it would require too much work to accommodate all of them. Instead, since their data output is intended to be universal—i.e. they produce video files which can be read on any computer—a better solution is to synchronize through the data itself. To do that, a marker in either the video or audio streams has to be placed, which will be recognized and decoded during the synchronization process.

It can be argued that pictures usually contain more information than sound, which makes a visual marker preferable. The easiest way of synchronization is to identify the real time of a given frame, thus synchronizing all of them if their relative time differences are known—which is exactly the case, since they all have relative time stamps since the beginning of video. To increase accuracy, it is better to have many such frames and develop an algorithm to find the most accurate synchronization time.

To simplify the synchronization, it is best if the source generating the visual marker already uses the same timeline as the data—i.e. it is best, though not mandatory, to use the very computer recording the data or maybe a different one that is synchronized with it (for example, through the time.windows.com service). The marker has to satisfy the following requirements, in one or more of the hereby described embodiments:
convey the whole message in just one frame (it cannot be assumed that the others will be read correctly in a multi-frame coding)
be easily and quickly read even in unfavorable conditions
be generated quickly even on slow machines
does not rely on any additional devices than those already required by the walkinsense software (as an example of a device which records, processes and analyzes on-line and real-time data)

It follows that an encoded image pattern displayed on the computer screen would be a good choice. However, it cannot be too complicated so as to make it easily readable. A black and white pattern is preferable as one or more of the hereby described embodiments—both to accommodate for difficult lighting conditions and devices which record in black and white. A correct recording of the marker cannot be taken for granted, which is why at least a checksum has to be encoded, too, as one or more of the hereby described embodiments. The most widely used kind of the above described image patterns are linear (i.e. one-dimensional) barcodes. They were chosen to be implemented as one or more of the hereby described embodiments, both because they satisfy all the requirements (in particular, being simple and quick to read) and because their popularity gave rise to open-source libraries both for barcodes generation (e.g. Barcode4J) and decoding (e.g. ZXing).

There are many types of linear barcodes used world-wide, the most popular being implemented according to regulations of ISO/IEC 15417, 15420, 16388 or 16390. They have various supported lengths of encoded digit strings, width of bars and checksum patterns. Out of those, the width was not important (as modern computer screens offer enough space for them) and the checksum at least had to be present as one or more of the hereby described embodiments. As for the length, the encoded message has to be considered. Computer time is usually stored in milliseconds since 01.01.1970, the current (say 19 Sep. 2011) being around 1.313.765.000.000-13 digits. Such that 11 digits is enough as one of the hereby described embodiments. UPC-A, one of the most popular and easily readable coding standard, is therefore a viable option for this embodiment, as it supports exactly 11 digits (the last, 12^{th}, is a checksum)—and its fixed length makes it actually quicker to process.

The synchronization process would be therefore as follows:
Display barcodes containing the current system time, for example in milliseconds on the screen.
During the tests, capture at least a few seconds of video containing the generated barcodes with the record device (mobile phone, webcam, camcorder, etc).
Upload the video file on the computer, extract frames containing barcodes. Choose at least one of them to match the video to the data.

As it will be easily understood by the skilled person, any suitable barcoding system can be used, namely 2D barcodes, whether stacked, such as PDF417, matrix codes, such as QR-code, or others, including high-density color barcodes or any other, provided it is able to encode a time reference or frame reference into a video stream.

As it will be easily understood by the skilled person, any error-correction information, e.g. a checksum, can be used in the barcode whether included in the data itself or simply making use of error-correction provided in the barcode standard in use, but an embodiment may also possible without error-correction information and, in this case, data may be then verified afterwards, e.g. statistically.

As it will be easily understood by the skilled person, the encoding of the time reference may be carried out using any of a variety of time-references (elapsed, real time, is milliseconds, in decimals or binary encoded . . . ) or frame-references (frame counter, mixed time and frame counter, . . . ). It is not necessary that each barcode displayed corresponds to one video frame, but that is preferable in most of the present embodiments. If the frame rate is especially high, for example in a very high-refresh rate monitor, then a barcode may even span two or more frames. In general, theses timings are variable as long as they are compatible with the desired time accuracy.

As it will be easily understood by the skilled person, synchronization may happen in a recorded video stream or in an online video stream.

To choose an appropriate frame for synchronization, there is a need of a method of comparing them. A good and straightforward one is to subtract the internal time stamp—which is relative to the first frame—from the time read from the barcode. The result can be interpreted as the real time of the first frame and as all of them are supposed to be the same, they will be henceforth used, especially for visual comparisons.

Charts 1 and 2 show local data (i.e. gathered during a few seconds) dispersion, it can already be seen that data points tend to oscillate around a main line, which can be supposed to be the best candidate for a synchronization time. Various algorithms were tested for identifying a point representative of the cloud. Due to the fact that some devices may have short-lived major errors in readings, any kind of averaging is normally excluded as a possible selection criterion and median was used instead—to choose the most common values in an embodiment.

The dispersion is mainly due to delays in barcode generation and a finite shutter speed of cameras, of which the latter is of greater importance and can result in ambiguous images if the shutter is open during the transition between the display of two various barcodes. It cannot be said for sure which of the two barcodes will be displayed. As the exposure time is in most situations less than the frame time (for example, for 30 fps, 1000/30=33 ms), it can be asserted that the accuracy of the reading is in most situations plus or minus one frame time, which is a good approximation of what can be observed in the above illustrated data. The exposure time is actually dependent on the sensitivity of the CCD matrix and quality of various optical parts of the recording system, which leads to a desirable relation between the accuracy of synchronization and the quality of recording device—better synchronization can be achieved with better devices, such as photo cameras instead of mobile phones.

For the comparison to be meaningful, it is inferred through testing that 20 consecutive frames will be enough for most situations. Supposing that the minimal frame rate of a device which can be used with a device which records, processes and analyzes on-line and real-time data, for example walkinsense products, is 5 frames per second, it follows that in most of the present embodiments the user will be advised to record a minimum of 20/5=4 seconds of good quality video containing barcodes. If less are found during the synchronization process, a warning may be displayed.

For modern computers, it does not take much more than a few milliseconds to read a barcode from an image (e.g. with ZXing library). The time increases with bad video quality, high video resolution and high compression (the last one is due to video decoding, not barcode reading), but is still reasonably fast. However, as the algorithm used tries to find a barcode in the supplied image very hard, the processing time is longer for negative readings than for positive ones and call for a seeking algorithm which minimizes the amount of video frames with no barcodes which need to be read before finding a set if barcodes.

The main window of the software for the device which records, processes and analyzes on-line and real-time data, walkinsense as example, allows the user to start an acquisition of motion and gait analysis for a certain patient. On the real-time acquisition it is possible to choose the record data with video. Just select “With video” and press the button “REC”.

A window with the barcode will be showed to allow the user to record it with the video recorder device such a camcorder, webcam, mobile phone, etc. In most of the present embodiments the user is advised to record barcodes both before and after the pressure data recording takes place in the following frame. This has the advantage of higher sync precision.

After recording video and data from the device which records, processes and analyzes on-line and real-time data, e.g walkinsense device, the videos can be associated to an appointment of data collection. On the importation moment, the algorithm implemented on the software will search for the barcode with the timescale of the computer in the video frame and will synchronize the video with the data.

After this, the data is synchronized and the user can make statistical analysis and export a smaller sample of the entire recorded data.

The above described embodiments are obviously combinable.

An example of one application for the disclosure is the monitoring football players training on the field.

A device would measure all the different exercises made during training. After minutes or hours of data collection, the data is analysed (e.g regarding to posture or plantar pressure distribution), after which it is possible to match the video recorded with a mobile camera and the collected data synchronized. This allows the user to analyse each moment of captured data, with precision, and correspond it with the movement of the player as recorded by the video camera.

The disclosure is obviously in no way restricted to the exemplary embodiments described and the skilled person will contemplate modifications without departing from the scope of the disclosure as defined in the claims.

### DESCRIPTION OF THE FIGURES

The following figures provide preferred embodiments for illustrating the description and should not be seen as limiting the scope of the disclosure.

FIG. 1a: Schematic representation of a first frame time with a mobile phone of 15 fps, wherein (M1) represents the median start time value, calculated using the correction of the error.

FIG. 1b: Schematic representation of a first frame time with a mobile phone of 90 fps, wherein (M2) represents the median start time value, calculated using the correction of the error.

FIG. 2: Schematic representation of a software embodiment for real-time data collection.

FIG. 3: Schematic representation of a software embodiment for real-time data collection.

FIG. 4: Schematic representation of a software embodiment for a barcode generator with actual time.

FIG. 5: Schematic representation of a software embodiment for video and data analysis window.

FIG. 6: Schematic representation of an embodiment.

FIG. 7: Schematic representation of an embodiment, wherein the synchronization of the data stream is also performed by the synchronization module (6).

FIG. 8: Schematic representation of an embodiment, wherein the data collecting processor (2) obtains the time- or frame-reference from another processor (1).

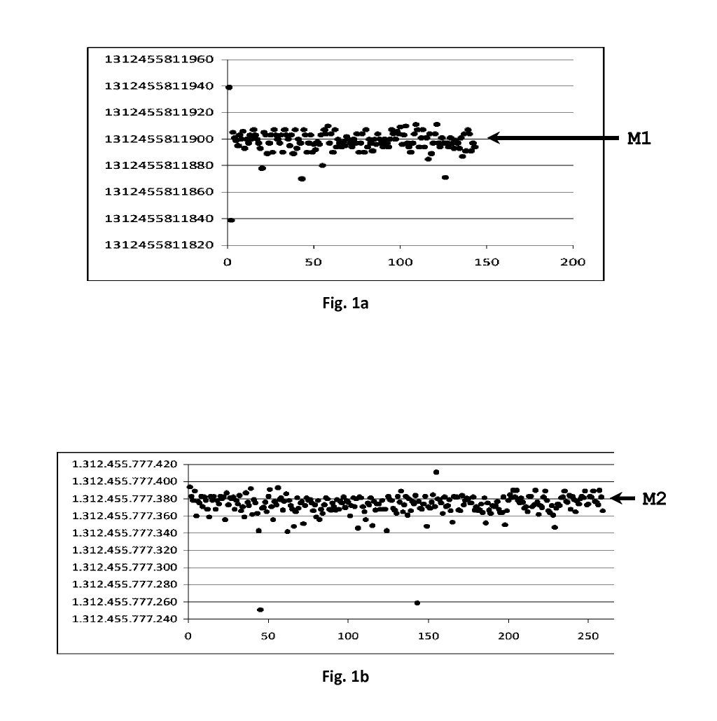

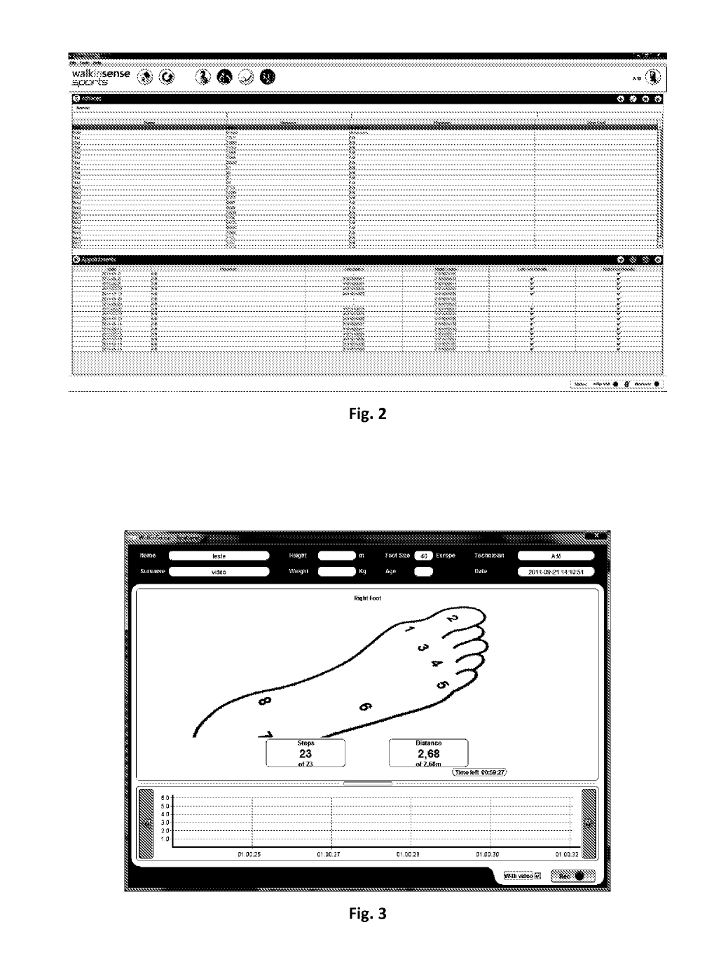

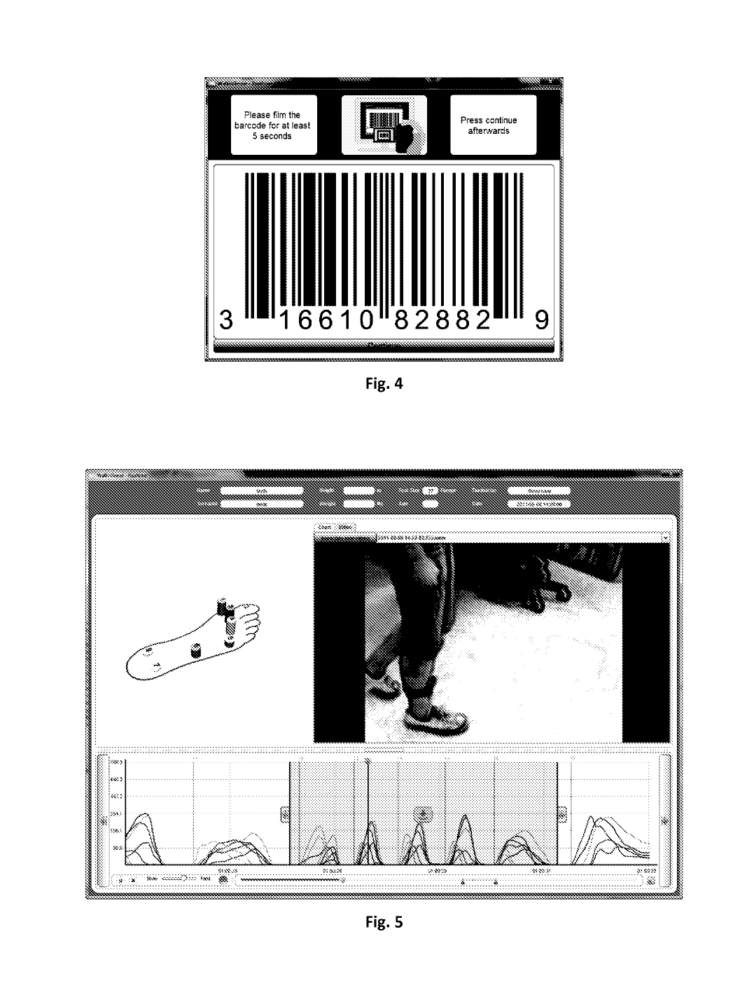

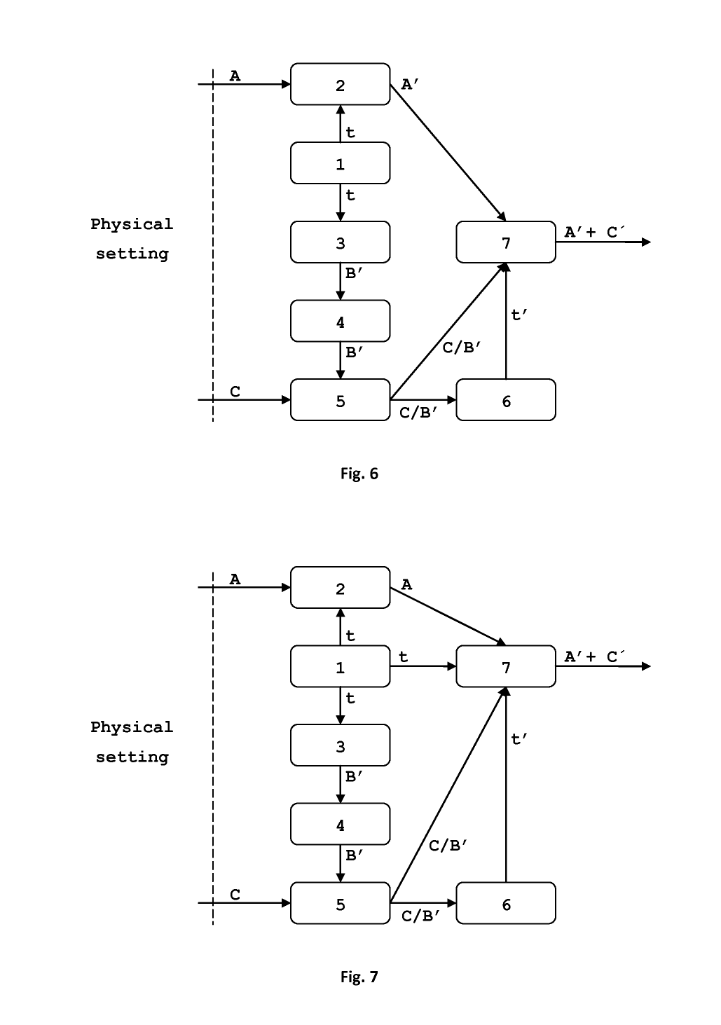

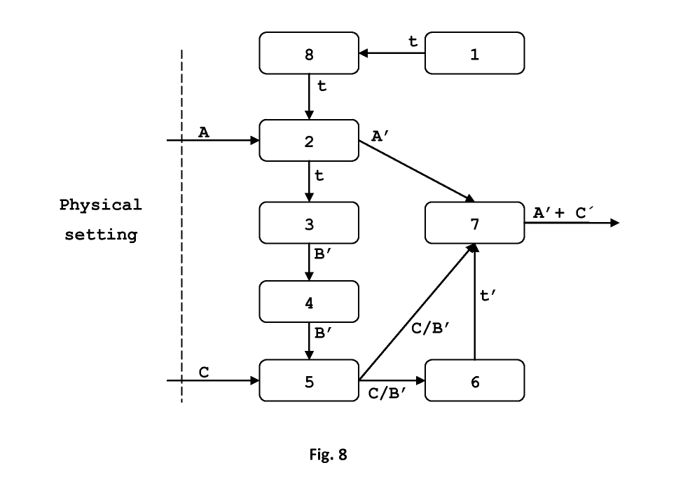

The following claims set out particular embodiments of the disclosure.

1. Method for synchronizing a video stream with a real-time data collection stream of the same and simultaneous physical setting comprising the steps of:
a. providing a time- or frame-reference (t) by the data processor (2) responsible for collecting the data stream (A) from the physical setting, or by another data processor (8) in temporal synchronization with the data processor (2) responsible for collecting the data stream (A) from the physical setting;
b. visually encoding (3) said time- or frame-reference (t) into an encoded image pattern and generating an encoded video stream (B′) comprising said encoded image pattern;
c. displaying (4) said encoded video stream (B′);
d. filming (5) said displayed encoded video stream (B′) by a camera responsible for collecting the video stream (C) from the physical setting and in the same video stream of said physical setting (C/B′);
e. decoding (6) said encoded image pattern from the filmed encoded video stream (C/B′) and obtaining the visually encoded time- or frame-reference (t′);
f. using (7) this time- or frame-reference (t′) to synchronize (A′+C′) the video stream of said physical setting (C) with the real-time data collection stream of said physical setting (A).

2. Method according to claim 1 wherein the step of visually encoding (3)
time- or frame-reference (t) into an encoded image pattern comprises generating a barcode with a time- or frame-reference (t).

3. Method according to claim 1 wherein the step of visually encoding (3) time- or frame-reference (t) into an encoded image pattern comprises generating a linear or 2D barcode with a numerical time-reference (t).

4. Method according to claim 1 wherein the step of visually encoding (3) time- or frame-reference (t) into an encoded image pattern comprises generating a black and white barcode with a numerical time-reference (t) in milliseconds.

5. Method according to claim 1 wherein the step of visually encoding (3) time- or frame-reference (t) into an encoded image pattern comprises generating a UPC-A barcode with a numerical time-reference (t) in milliseconds.

6. Method according to the claim 2 wherein the step of visually encoding (3) time or frame-reference (t) into an encoded image pattern comprises generating a linear or 2D barcode with an alphanumerical time- or frame-reference.

7. Method according to claim 1 wherein the 2D barcode is a 2D matrix code, 2D stacked code or a 2D high-density color barcode, or combinations thereof.

8. Method according to claim 1 wherein filming (5) said displayed encoded video stream (B′) occurs before, or after, or before and after, the simultaneous filming (5) of the video stream (C) and collecting the real-time data (A) from the same physical setting.

9. Method according to claim 1 wherein the step of decoding (6) of said encoded image pattern, from the filmed encoded video stream (C/B′), and obtaining the visually encoded time- or frame-reference (t′), comprises calculating the median time- or frame-reference from a plurality of frames from the encoded video stream (C/B′).

10. A computer program comprising computer program code means adapted to perform the steps of claim 1 when said program is run on a processor.

11. A computer readable medium comprising the computer program according to claim 1.

12. System for synchronizing a video stream with a real-time data collection stream of the same and simultaneous physical setting wherein it is configured to perform the steps of claim 1.

13. System for synchronizing a video stream with a real-time data collection stream of the same and simultaneous physical setting comprising:
a. a time- or frame-reference module (1) from a data processor (2) configured for collecting the data stream (A) from the physical setting, or from another data processor (8) in temporal synchronization with the data processor (2) configured for collecting the data stream (A) from the physical setting;
b. a generator (3) of a visually encoded video stream (B′), said generator (3) comprising a visual encoder of encoded image patterns of the time- or frame-reference (t) of the time- or frame-reference module (1);
c. a display (4) connected to the generator (3) of said encoded video stream (B′) able to display said encoded video stream (B′) for filming by a camera (5) for collecting the video stream (C) from the physical setting and in the same video stream (C/B′) of said physical setting video stream (C);
d. a decoder (6) of the visually encoded time- or frame-reference (B′), connected to the output of the camera (5) for filming said encoded video stream (C/B′) with encoded image patterns (B′), configured for decoding and obtaining the visually encoded time- or frame-reference (t′);
e. a synchronization module (7) connected to said decoded time- or frame reference (t′) and to the unsynchronized streams (C/B′), configured for outputting the synchronized streams of the video stream (C′) and the realtime data collection stream (A′) of said physical setting.

14. System according to claim 13 wherein the visual encoder of said time or frame-reference of the generator (3) of the encoded video stream (B′), comprises a barcode generator connected to the time- or frame-reference (t) from the time- or frame-reference module (1).

15. System according to claim 13 wherein the visual encoder of said time or frame-reference of the generator (3) of the encoded video stream (B′), comprises a linear or 2D barcode generator connected to a numerical time reference (t) from the time- or frame-reference module (1).

16. System according to claim 13 wherein the visual encoder of said time or frame-reference of the generator (3) of the encoded video stream (B′), comprises a black and white barcode generator connected to a numerical time reference (t) in milliseconds from the time- or frame-reference module (1).

17. System according to claim 13 wherein the visual encoder of said time or frame-reference of the generator (3) of the encoded video stream (B′), comprises a UPC-A barcode generator connected to a numerical time- or frame reference (t) from the time- or frame-reference module (1).

18. System according to claim 14 wherein the visual encoder of said time- or frame reference of the generator (3) of the encoded video stream (B′), comprises a linear or 2D barcode generator connected to an alphanumerical time- or frame reference (t) from the time- or frame-reference module (1).
